(19) United States
(12) Patent Application Publication
(10) Pub. No.: US 2008/0097891 A1
(43) Pub. Date: Apr. 24, 2008

(54) Virtual Stock Market Service Based on Search Index

(75) Inventor: Yong Duk Park, Kyunggi-do (KR)

Correspondence Address: Law Office of Mark J. Spolyar, 38 Fountain Street, San Francisco, CA, 94114, US

(73) Assignee: Yahoo! Inc.

(21) Appl. No.: 11/608,546

(22) Filed: Dec. 8, 2006

(30) Foreign Application Priority Data
Oct. 19, 2006 (KR) 10-2006-101891

(51) Int. Cl. G06Q 40/00

(52) U.S. Cl. 705/37; 705/35

(57) ABSTRACT

The present application provides a method and system which provide a virtual stock exchange service. In one particular implementation, the system includes a resource locator database, a resource locator search server, a listed resource domain database, a user database, and a virtual stock trading management server. The resource locator database includes search information for a resource domain forming a search pool. The search information includes a search score assigned to the resource domain and one or more resource locators associated with the resource domain. The resource locator search server searches the resource locator database and transmits a result list of the search in response to a user's query. The listed resource domain database includes information of the resource domain categorized as a listed resource domain or a listing candidate resource domain according to the search score of the resource domain. The user database includes information of the users participating in a trade of virtual stocks. The virtual stock trading management server manages the trade of virtual stocks and updates the listed resource domain database and the user database for reflecting a result of the trade.

### TECHNICAL FIELD

The present invention generally relates to search engines.

### BACKGROUND

A search engine is an online database system operating as an information mediator on the Internet. In one permutation, search engines collect enormous amounts of information from millions of resource locators such as web pages, using an information collecting program, such as a robot, a spider, a worm or a crawler, and classify the resource locators into many directories according to their subjects, so as to lead users to desired information through hypertext techniques. Also, a portal site is the first site to be visited when a user goes online to obtain information from the Internet, which contains information on various subjects to satisfy the user's desire. Since the portal site operates as the search engine in general, the term portal site and the term search engine are used interchangeably in this disclosure.

Generally, a user (or a netizen) obtains information from the search engine according to his/her private inclination or personal necessity, or a social issue. Therefore, by analyzing the keywords used for searches and the resources retrieved by the users, the public opinions or the public inclinations of netizens can be predicted and frequently searched resources for a short or long time period can be found.

Recently, the number of users using the Internet are rapidly increasing, most of them retrieving information using the portal site, i.e. the search engines. Each portal site can make a great profit depending on how well it is known to the user and how often it is used by the user. Meanwhile, such expansion has lead to a strong competition among portal site enterprises. Nowadays, in order to gain more recognition and lure more users to their portal sites, each portal site provides not only the information search service but also other various services such as news, online shopping malls, and online communities. Further, each portal site continuously pursues new and creative content and services to induce and motivate users to increasingly use the portal site.

These approaches, basically, should be made with consideration as to which content and/or service effectively interest users and how this interest can be translated into increased usage of the portal site. In this connection, it is useful to consider that most people are interested in activities that provide fulfillment and/or tangible material gains and most human activities are directed toward obtaining such things. Therefore, there is a strong need for a new service material which motivates users psychologically or economically to use the search engine.

Meanwhile, stock trading is well entrenched in the real economic market to have a strong grip on the general public and is one of main source of fulfillment and material gain for the investors. The price of the stock varies according to the condition of the economic market and in effect reflects the public opinion of the market. Thus, one can infer public opinion in the market by analyzing the price of a stock.

In this regard, a method for providing a trading service of virtual stocks is known, wherein users (members) participating in the trade recommend a specific item (a specific web site), only the virtual stocks for the recommended items are traded, and when searched, the predetermined stock price is shown. However, according to the known method, the trading subject is limited only to the stocks issued by the web sites that are recommended by some users and the stock price is influenced only by the transaction between the participants of the virtual stock trade, thereby not reflecting any objective value assessment index, such as public opinion or current (or real, substantial) search trend. Therefore, the trade results have no connection with real search activities and do not reflect objective search trends.

### SUMMARY

The present invention provides a method for a virtual stock trading service which motivates users to continuously use a specific search engine with interest, wherein substantial search trends of the search engine and public opinions obtained thereby (as a result of such search activities/trends) are reflected in the stock price.

In accordance with one embodiment of the present invention, a method and system for providing a virtual stock trading service is provided. In the virtual stock exchange service, users are allowed to buy and sell search stocks that correspond to one or more resource locators. Further, in some implementations, a selected search stock is conditionally listed and de-listed on the virtual stock exchange service based on a monitored search trend associated with the one or more resource locators corresponding to the selected search stock.

In accordance with another embodiment of the present invention, a system for providing a virtual stock trading service is provided. The system includes a resource locator database, a resource locator search server, a listed resource domain database, a user database, and a virtual stock trading management server. The resource locator database includes search information for a resource domain forming a search pool. The search information includes a search score assigned to the resource domain and one or more resource locators associated with the resource domain. The resource locator search server searches the resource locator database and transmits a result list of the search in response to a user's query. The listed resource domain database includes information of the resource domain categorized as a listed resource domain or a listing candidate resource domain according to the search score of the resource domain. The user database includes information of the users participating in a trade of virtual stocks. The virtual stock trading management server manages the trade of virtual stocks and updates the listed resource domain database and the user database for reflecting a result of the trade.

### BRIEF DESCRIPTION OF THE DRAWINGS

FIG. 1 illustrates a block diagram of a system according to one embodiment of the present invention.

FIG. 2 illustrates a flow chart for changing search scores in accordance with the user's information search according to one embodiment of the present invention.

FIG. 3 illustrates a flow chart for changing resource domain categories in accordance with the search score according to one embodiment of the present invention.

FIG. 4 illustrates a listed resource domain database containing information of one or more resource domains.

FIG. 5 illustrates a flow chart for virtual stock trading according to one embodiment of the present invention.

FIG. 6 illustrates a computing system architecture, which may be used to implement a method and system according to one embodiment of the present invention.

### DESCRIPTION OF EXAMPLE EMBODIMENT(S)

The present invention, in one implementation, provides a method and system for providing, over a computer network, not only an information search service, but also a virtual stock trading service using virtual stocks issued for resource domains to stir interest among users. In this disclosure, the term “resource domain” refers to a location of aggregate resources provided on the network, which can be reached by one or more resource locators. Further, the resources may correspond to web pages and links, media files such as audio, image and video files, metadata about such resources. For example, a resource domain may correspond to all network resources addressable with a URL including a given domain name, such as “yahoo.com”, in addition to one or more directory and file identifiers, or common gateway interface strings, and the like.

In one embodiment of the present invention, a search score is assigned to a resource domain forming a search pool. One or more resource locators associated with the resource domain may be listed in a search result list by a search engine. The search score is used to classify the resource domain as a listed resource domain or a listing candidate resource domain which may issue virtual stocks. The search score is an aggregate score or value based on other composite values/scores reflecting the popularity of a resource locator according to user search activity, i.e., the real user's searches, based, in one implementation, on analysis of search logs containing user queries and click-stream data. For example, the search score of the resource domain can vary according to various factors, such as the number of times the resource locators of the resource domain are listed in the users' search result list, the number of times an item such as a keyword is found in the resource domain, or the number of times the users select the resource locators of the resource domain among the search results list and visit the resource domain, etc. Based on the search score, resource domains are categorized as a not-listed resource domain, a listing candidate resource domain, a listed resource domain or a stopped resource domain. Some listed resource domains may be further categorized as a controlled resource domain.

A predetermined threshold, i.e. a listing threshold, can be applied to the respective search scores of the resource domains to classify them in one of a plurality of categories. When a search score of a current not-listed resource domain is less than the listing threshold, the resource domain remains in a not-listed resource domain category. When the search score of the current not-listed resource domain is equal to or greater than the listing threshold, the resource domain is categorized as a listing candidate resource domain. Further, when a search score of a current listing candidate resource domain is equal to or greater than the listing threshold, the resource domain is categorized as a listed resource domain category. When a search score of a listed resource domain is less than the listing threshold, the resource domain is categorized as a controlled resource domain unless the resource domain is already categorized as a controlled resource domain. If a search score of a controlled resource domain among the listed resource domains is less than the listing threshold, the resource domain is categorized as a stopped resource domain.

Virtual stocks are not issued for the not-listed resource domain. Virtual stocks for the listing candidate resource domain may be issued and offered for public subscriptions, but the virtual stocks issued for the listing candidate resource domain cannot be actually traded between general investors. If the listing candidate resource domain maintains the search score equal to or above the listing threshold for a given period of time, the category of the resource domain changes from a listing candidate resource domain to a listing resource domain, allowing general investors to trade the stocks issued for the resource domain. If the search score of the listed resource domain dips below the listing threshold during a given period of time, the resource is further categorized as a controlled resource domain to warn the investors. If a controlled resource domain maintains the search score below the listing threshold for a given period of time, it is categorized as a stopped resource domain and the trading of the stocks issued for the stopped resource domain are suspended. The stopped resource domain may be later reclassified as a listed resource domain if the search score increases above the listing threshold according to a change in the search trend.

The search scores associated with the resource domains fluctuates according to the user search trends with the passage of time. Fluctuations of a search score for a predetermined time period leads to the change in the categories for a given resource domain. The fluctuation in the search score acts as an index which reflects the development of the users' preference regarding the search and influences investors' mind to give rise to change in the virtual stock price.

In the following, example embodiments of the present invention will be described in detail with reference to the accompanying drawings. It will be apparent, however, that these embodiments may be practiced without some or all of these specific details. In other instances, well known process steps or elements have not been described in detail in order not to unnecessarily obscure the description of the invention.

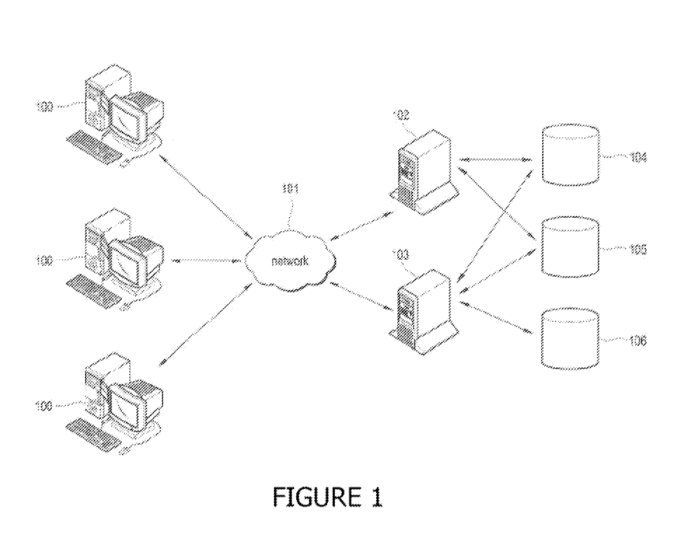

FIG. 1 illustrates a block diagram of a system according to one embodiment of the present invention. A user terminal 100 can access a resource locator search server 102 and a stock trading management server 103 through a network 101.

The resource locator search server 102 can access a resource locator database 104, which includes a plurality of resource locators for resource domains forming a search pool, search the resource locator database 104 in response to a query from the terminal 100, and obtain a search result list to be returned to the user's terminal over the network 101, which in some embodiments can be an internet. The resource locator database 104 contains access information for resource domains and search scores respectively assigned to the resource domains. The resource locator search server 102 updates the search scores of the resource domains in the resource locator database 104 whenever it performs a search activity and reflects the updates to a listed resource domain database 105. Search scores for the resource domains can also be updated in a background process that analyzes a log of search activity generated by the resource locator search server 102. In one implementation, the background process can be run periodically (e.g., hourly, daily, etc.) to update the various classifications of the resource domains.

The stock trading management server 103 monitors the fluctuation of search scores of the resource domains and categorizes the resource domains respectively as one of the not-listed resource domain, the listing candidate resource domain, the listed resource domain and the stopped resource domain. Then, the stock trading management server 103 creates or updates information of resource domains included in the listed resource domain database 105. Some of the listed resource domains are further categorized into a controlled resource domain category according to the fluctuation of the search score. As mentioned above, the fluctuations of the search score of the resource domain are reflected in the listed resource domain database 105 by the resource locator search server 102. The stock trading management server 103 manages the trading of virtual stocks issued by the resource domains in the listed resource domain database 105 and, whenever a trade is made, reflects an information change according to the trade (for example, a price change of the virtual stock, a change of the user's information, etc.) in the listed resource domain database 105 and a user database 106. The user database 106 contains information of users participating in the virtual stock trading, such as the users' ID information and cyber money information. Changes to the user database 106 are managed by the stock trading management server 103.

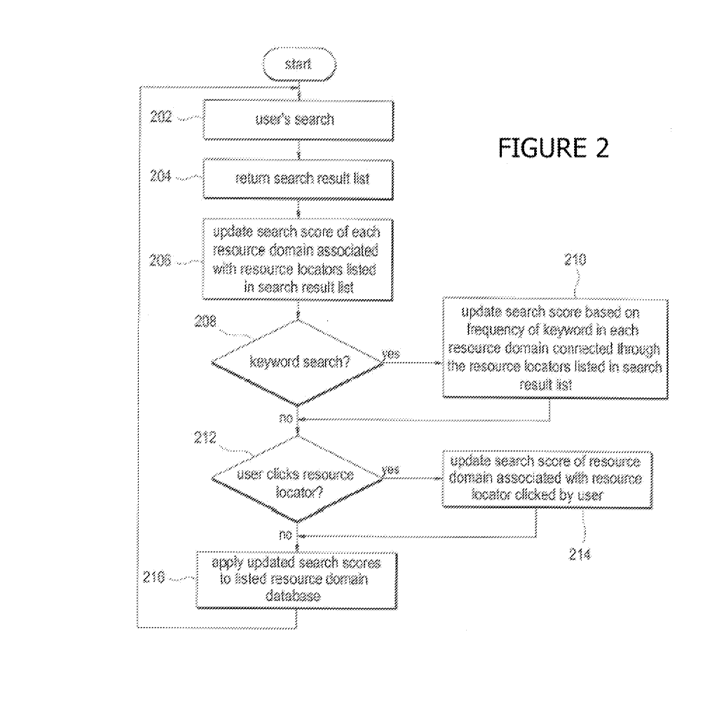

FIG. 2 illustrates a flow chart for changing search scores in accordance with the user's information search according to one embodiment of the present invention.

As mentioned above, whenever a search operation is performed in response to a query, the resource locator search server 102 records the fluctuation of the search scores of the resource domains in the resource locator database 104 and the listed resource domain database 105. The detailed explanation regarding the fluctuation of the search scores is shown below.

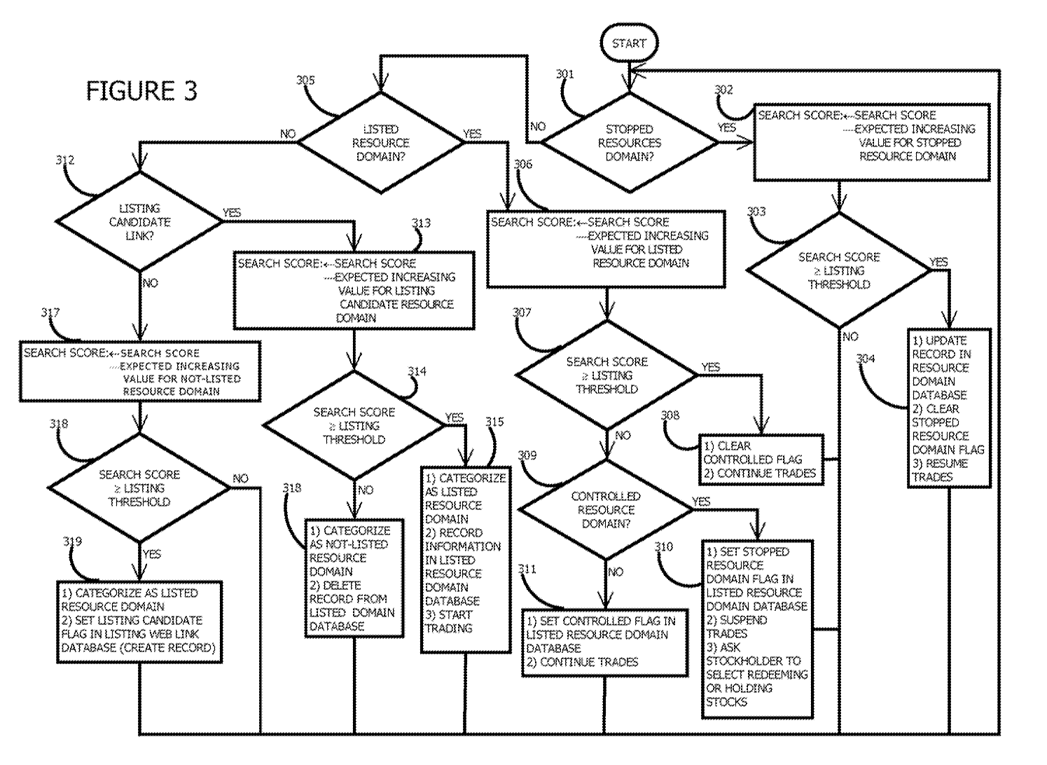

First, if a user request a search (for example, a keyword search or a directory search) (operation 202), the resource locator search server 102 searches the resource locator database 104 and returns a search result list to the user's terminal 100 (operation 204). At that time, the resource locator search server 102 updates the search scores of the resource domains (for example, incrementing the search scores of the resource domains) associated with one or more resource locators listed in the search result list (operation 206). Next, if the user's search is a keyword search (operation 208), for the resource domains associated with one or more resource locators listed in the search result list, the number of times the keyword is listed in the resource domain connected through the resource locators is computed and each increment determined according to the computed number is added respectively to the corresponding search score (operation 210). Further, a predetermined increment is added to the search scores of some resource domains having one or more resource locators which are selected and clicked among the search result list by the user (operations 212 and 214). In this embodiment, the number of times the resource locators of the resource domain are listed in the user's search result, the number of times the search keyword is found in resource domain connected through the resource locators, and the number of times the user selects and clicks the resource locators among the search result list are employed as factors indicating the user's search trend which influences the resource domain search scores but any other element can be also used so long as the element substantially reflects the user's search trend. For each factor, the predetermined increment to be added to the search scores may be different from others. For example, since the resource domains associated with resource locators selected and clicked by the user can be valued highly than the resource domains associated to resource locators included in the search result list, the increment added to the search scores related to the resource domains actually visited may be higher. After changing the search scores according to the user's search, the procedure proceeds to operation 202 for processing the next user's search. It should be noted that those search scores might be also updated in a predetermined way for a predetermined period (for example, a search score of a resource domain may be decreased by an amount determined according to the category of the resource domain periodically, as explained below referring to FIG. 3). Alternatively, in one embodiment of the present invention, a ranking according to the location of the resource locators in user's search result, a ranking according to the number of times the search keyword is found in the resource domain, and a ranking according to the number of times the user selects and clicks the resource locators among the search result list, etc. may be managed periodically, and the search score assigned to the resource domain may be fluctuated based on a periodic ranking fluctuation. For example, a predetermined increment/decrement may be added/subtracted to/from the search score of the resource domain, according to ascent/descent of a ranking according to a location of the resource locators in user's search result, a ranking according to the number of times the search keyword is found in the resource domain, and a ranking according to the number of times the user selects and clicks the resource locators among the result list, etc. for a predetermined period.

To allow the resource locator search server 102 to track user clicks, the search result lists, in one implementation, include URLs that correspond to the resource locator search server 102, but also include encoded information that maps to a URL of the underlying network resource. Accordingly, the resource locator search server 102, in one implementation, generates encoded or plaintext URL identifies for one or more URLs of the search results, and adds these URL identifiers as a parameter to a redirection URL that identifies the resource locator search server 102. For example, the encoded URL identifier for a given search result may be one or more strings and be included in the following example URL: http://search.yahoo.com/_rdrct=UJASf4&SIG=llaygd. In one implementation, resource locator search server 102 stores the encoded URL identifier in association with the corresponding search result list for later use. After generating one or more encoded URLs for inclusion in the search results, resource locator search server 102 may transmit the results to the requesting client node.

When the user clicks on the hyperlink provided in the search result list entry, the URL is provided to the browser program. The browser program, in turn, accesses the resource locator search server 102, which in turn transmits a redirection message to the user's browser. In particular implementations, redirection generally refers to transmitting a message from a server to a client application, for example, that causes the client application to access another server or resource without intervention or action by the end-user. Redirection can be accomplished in a number of different ways. For example, in connection with HTTP, redirection messages can be implemented using refresh meta tags, such as

<html><head>
<meta http-equiv=“refresh” content=“0; url=http://www.yahoo.com/”>.

### In addition, redirection messages can be implemented using HTTP refresh headers.

HTTP/1.1 200 ok
Refresh: 0; url=http://www.yahoo.com/
Content-type: text/html
Content-length: 78
Follow <a href=“http://www.yahoo.com/”>link</a>.

Redirection can also be accomplished by transmitting an HTML page including JavaScript code operative to accomplish redirection. Other suitable redirection methods can be used for other protocol environments.

FIG. 3 illustrates a flow chart for changing resource domain categories in accordance with the search scores according to one embodiment of the present invention.

First, the stock trade management server 103 determines whether the resource domain is a stopped resource domain or not. If so, the stock trade management server 103 subtracts an expected increasing value for the stopped resource domain (a predetermined amount by which the search score of the stopped resource domain is expected to increase in the predetermined time interval) from the current score (operation 302). After determining whether the updated search score is equal to or greater than the listing threshold (303), if so, a stopped resource domain flag of the corresponding resource domain in the listed resource domain database 105 is reset, i.e. the corresponding resource domain returns to the listed resource domain category. The stocks from the resource domain are again traded between the investors after information of the resource domain is recorded in the listed resource domain database 105. Alternatively, if the search score is less than the listing threshold, the resource domain remains in the stopped resource domain category.

At operation 301, if the resource domain is not a stopped resource domain, the stock trade management server 103 determines whether the resource domain is a listed resource domain. If so, an expected increasing value for the listed resource domain (a predetermined amount by which the search score of the listed resource domain is expected to increase in the predetermined time interval) is subtracted from the search score of the resource domain (operation 306). After determining whether the updated search score is equal to or greater than the listing threshold (operation 307), if so, a controlled flag of the corresponding resource domain is reset in the listed resource domain database 105 (i.e., if the controlled flag has been set, the flag will be cancelled and if not, no process is done.). If the updated search score is less than the threshold, whether the corresponding resource domain is a controlled resource domain is determined (operation 309). If so, a stopped flag of the corresponding resource domain in the listed resource domain database 105 is set, trades of the stocks from the resource domain are suspended, and stockholders are asked to select redeeming the stocks at a face-value or holding stocks (operation 310). At operation 309, if the resource domain is determined not to be a controlled resource domain, trades of stocks from the resource domain continues after a controlled flag of the corresponding resource domain is set in the listed resource domain database 105 (operation 311). The controlled flag is just prepared for securing investors' trading activity and the resource domain having the controlled flag set is still included in the listed resource domain category. Therefore, the stocks floated from the controlled resource domain are still traded as before.

At operation 305, if the resource domain is determined not to be a listed resource domain, the stock trade management server 103 determines whether the resource domain is a listing candidate resource domain (operation 312). If so, an expected increasing value for the listing candidate resource domain (a predetermined amount which the search score of the listing candidate resource is expected to increase by in the predetermined time interval) is subtracted from the current search score of the link (operation 313). Whether the updated search score is equal to or above the listed threshold is determined (operation 314), and, if so, the resource locator is categorized as a listed resource domain in the listed resource domain database 105. Namely, the stock trade management server 103 resets the listing candidate flag of the corresponding resource domain in the listed resource domain database 105 and records several data for trading the stocks, such as a price of the stock. Alternatively, if the updated search score is determined to be less than the listing threshold at operation 314, the corresponding resource domain is categorized as the not-listed resource domain and the records of the corresponding resource domain in the listed resource domain database 105 are deleted (operation 316).

If the resource domain is neither a listed resource domain nor a listing candidate resource domain, an expected increasing value for the not-listed resource domain (a predetermined amount by which the search score of the not-listed resource domain is expected to increase in the predetermined time interval) is subtracted from the current search score of the resource domain (operation 317). Whether the updated search score is equal to or above the listing threshold is determined (operation 318) and, if so, the resource domain is categorized into a listing candidate resource domain. Then, a listing candidate flag of the resource domain is set and a record related to the resource domain is created in the listed resource domain database 105 (operation 319). If the updated search score is less than the threshold, the corresponding resource domain is categorized as a not-listed resource domain and no further process is performed. The stock trade management server 103 performs the above operations for one or more of the resource domains associated to the resource locators in the resource locator database 104.

With regard to the fluctuation of the search score, according to the above mentioned embodiment in which the ascent or the descent of the search score is determined based on a ranking according to a location of the resource locators in user's search result, a ranking according to the number of times the search keyword is found in the resource domain indicated by the resource locators, and a ranking according to the number of times the user selects and clicks the resource locators amount the result list, etc., the operations 302, 306, 313 and 318, all of which are provided against continuously increasing of the search score, may be omitted because the ascents and the descents of the search score of the resource domain may be repeated according to a given criteria and the search score will not be continuously increased without limit.

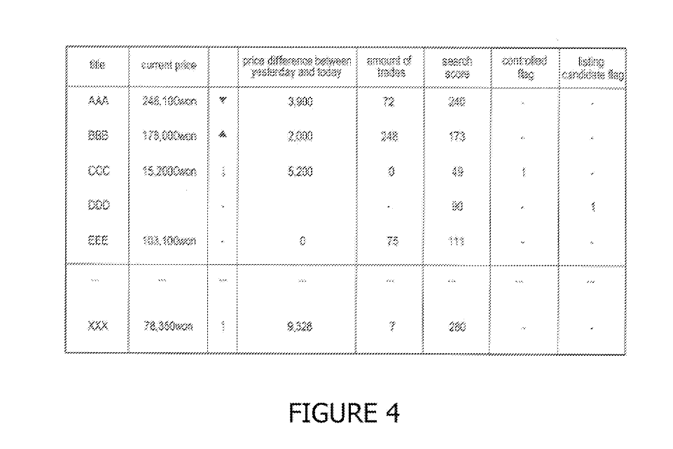

FIG. 4 illustrates an example listed resource domain database containing information of one or more resource domain.

The listed resource domain database 105 may contain information of the listed resource domains and the listing candidate resource domains, such as a title of each resource domain, a current price of stock issued by each resource domain, a stock price difference between yesterday and today, an amount of trades, a current search score, a controlled flag, and a listing candidate flag. If a listed resource domain is categorized as a controlled resource domain due to a depression of a search score, the controlled flag of the resource domain is set to warn investors. If the listing candidate flag is set, it means that the resource domain still remains in the listing candidate resource domain category. Since the listing candidate resource domain is capable of issuing virtual stocks and offering the stocks for public subscriptions but the virtual stocks issued by the listing candidate resource domain cannot be traded between general investors yet, only the title and the listing candidate flag are indicated in the resource domain database.

The listed resource domain database 105 may also contain a stopped resource flag (not shown). When a listed resource domain categorized as a controlled resource domain changes its category to a stopped resource domain due to continuous depression of the search score, the stopped flag of the resource domain is set. Since a trade of the stocks from the stopped resource domain should be suspended, the trading information for the stopped resource domain is deleted in the listed resource domain database. But, if the search score of the stopped resource domain ascends later, the resource domain can return to the listed resource domain category. In such a case, the trading information for the returned resource domain is recorded again in the listed resource domain database. Alternatively, the stopped resource domain can be managed in a separate database.

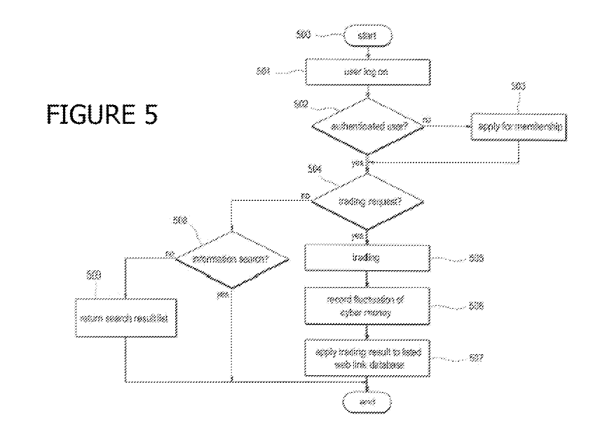

FIG. 5 illustrates an example flow chart for virtual stock trading according to one embodiment of the present invention.

A user can log on to a stock trade server 103 through a user terminal 100. When a user's attempts to log in, the stock trades server 103 searches the user database 106 and authenticates the user (operation 502). If the user cannot be authenticated, the server invites a user to take steps of an application for membership (operation 503). After the authentication, the stock trade server 103 determines whether the user's request is a trading request (operation 504). If so, the stock trading is achieved in a similar way to actual stock trading in a real stock market (operation 505). However, the virtual stock trading is characterized as being performed with virtual stock cyber money. The virtual stock cyber money possessed by a user and its fluctuation are recorded in the user database (operation 506). The virtual stock cyber money, which is a kind of a point provided by a portal site, is used only in trading virtual stocks exclusively in the portal site. The stock trading management server 103 reflects the changes resulting from the virtual stock trades to corresponding items in the listed resource domain database (such as the stock price, the price difference between yesterday and today, the amount of trades, etc.) (operation 507). If the user gives a data search request not a trading request, the stock trading management server 103 searches the listed resource domain database 105 and returns the result list to the user's terminal (operation 509).

According to one embodiment of the invention, a predetermined amount of virtual stock cyber money may be given to a user when the user applies for membership. The virtual stock cyber money may also be obtained by exchanging the general cyber money given to a user according to the user's various activities in the portal site (i.e., various activity achievements except virtual stock trading). A predetermined reference rate of exchange may be applied to exchanging cyber money. The virtual stock cyber money accumulated through virtual stock trades may be used in a separate online shopping mall operated by the portal site or for various premium services provided by the portal site after being exchanged to the general cyber money. The exchanging of the virtual stock cyber money to the general cyber money is also achieved according to the reference rate of exchanging. Moreover, if a user wants to convert the own virtual stocks into the virtual stock cyber money, the stocks may be converted to the virtual stock cyber money under a exchanging rate determined according to a current search score assigned for the resource domain from which the stocks being converted has been issued (this exchanging rate may be different the above mentioned reference rate). Alternatively, in one embodiment of the invention, the general cyber money may be used for the stock exchanges without any money exchange.

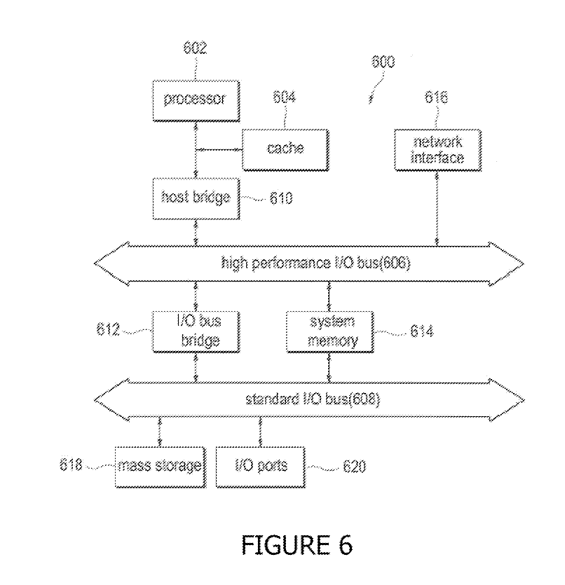

While the methods of the present invention have been described above with reference to specific embodiments, some or all of the elements or operations thereof may be implemented using a computer system having a general purpose hardware architecture. FIG. 6 illustrates an example computing system architecture, which may be used to implement the above described embodiments, which may be used to perform one or more of the processes described herein. In one implementation, hardware system 600 comprises a processor 602, a cache memory 604, and one or more software applications and drivers directed to the functions described herein.

Additionally, hardware system 600 includes a high performance input/output (I/O) bus 606, and a standard I/O bus 608. A host bridge 610 couples processor 602 to high performance I/O bus 606, whereas I/O bus bridge 612 couples the two buses (606, 608) to each other. A system memory 614 and a network/communication interface 616 couple to bus 606. Hardware system 600 may further include video memory (not shown) and a display device coupled to the video memory. Mass storage 618, and I/O ports 620 couple to bus 608. Hardware system 600 may optionally include a keyboard and pointing device, and a display device (not shown) coupled to bus 608. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 600 are described in greater detail below. In particular, network interface 616 provided communication between hardware system 600 and any of a wide range of networks, such as an Ethernet (e.g., IEEE 802.3) network, etc. In the case of the resource locator search server 102, the network interface 616 interfaces between the hardware system 600 and the network connected to the resource locator database 104 and the resource domain database 105 for allowing the hardware system 600 to manage those databases. Similarly, in the case of the stock trading management server 103, the network interface 616 interfaces between the hardware system 600 and the network connected to the resource domain database 105 and the user database 106 for allowing the hardware system 600 to manage those databases. Mass storage 618 provides permanent storage for the data and programming instructions to perform the above described functions implemented in the resource locator search server 102 or the stock trading management server 103, whereas system memory 614 (e.g., DRAM) provides temporary storage for the data and programming instructions when executed by processor 602. I/O ports 620 are one or more serial and/or parallel communication ports that provide communication between additional peripheral devices, which may be coupled to hardware system 600.

Hardware system 600 may include a variety of system architectures; and various components of hardware system 600 may be rearranged. For example, cache 604 may be on-chip with processor 602. Alternatively, cache 604 and processor 602 may be packed together as a “processor module,” with processor 602 being referred to as the “processor core.” Furthermore, certain implementations of the present invention may not require nor include all of the above components. For example, the peripheral devices shown coupled to standard I/O bus 608 may couple to high performance I/O bus 606. In addition, in some implementations only a single bus may exist, with the components of hardware system 600 being coupled to the single bus. Furthermore, hardware system 600 may include additional components, such as additional processors, storage devices, or memories. As discussed below, in one embodiment, the operations of the resource locator search server 102 or the stock trading management server 103 described herein are implemented as a series of software routines run by hardware system 600. These software routines comprise a plurality or series of instructions to be executed by a processor in a hardware system, such as processor 602. Initially, the series of instructions are stored on a storage device, such as mass storage 618. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 616. The instructions are copied from the storage device, such as mass storage 618, into memory 614 and then accessed and executed by processor 602.

An operating system manages and controls the operation of hardware system 600, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g., a processor, a computer, etc.).

According to embodiments of the present invention, users of a search engine, who are interested in a virtual stock trading service provided by the search engine and participate in trading virtual stocks issued from resource locators, are motivated to continuously use the search engine with interest.

Also, with respect to one or more resource locator registered to the search engine, the corresponding resource, such as an web site will become more widely known and, as a result, increase in advertisement power and further promotion opportunity will follow, as the resource locator becomes listed in the virtual stock market and the virtual stocks are traded between the users. Thus, numerous resource locators can be lured to register to the search pool of the search engine providing such virtual stock trading service, and this result may lead to the expansion of the information search pool that can be provided by the corresponding search engine and to the diversification of the information provided.

Moreover, according to embodiments of the present invention, a search ranking, which is obtained from the search scores and a stock price scores, can be used to determine the order of listing in the search result list. In such a case, since the search scores and the stock price scores reflects the frequency of the searches, the rate of the clicks, etc. for each resource domain, the listing order can be determined based on the usefulness of the search over all the resource locators.

While the present invention has been shown and described with respect to a preferred embodiment, those skilled in the art will recognize that various changes and modifications may be made without departing from the spirit and scope of the invention as defined in the appended claims.

1. A method, comprising
providing a virtual stock exchange service allowing users to buy and sell issued search stocks, each search stock corresponding to one or more resource locators; and
conditionally listing and de-listing a selected search stock on the virtual stock exchange service based on a monitored search trend associated with the one or more resource locators corresponding to the selected search stock.

2. The method of claim 1, wherein the one or more resource locators corresponding to the selected search stock are associated with a resource domain included in a search pool and are listed in a search result list generated by a search engine.

3. The method of claim 2, wherein the operation of conditionally listing and de-listing a selected search stock on the virtual stock exchange service includes categorizing the resource domain as one of a not-listed resource domain, a listing candidate resource domain, a listed resource domain and a stopped resource domain based on the monitored search trend, wherein some of the listed resource domain can be further categorized to a controlled resource domain.

4. The method of claim 3, wherein the monitored search trend is indicated by a search score assigned to the resource domain, the search score being determined based on the number of times the one or more resource locators corresponding to the selected search stock are included in the search result list.

5. The method of claim 3, wherein the monitored search trend is indicated by a search score assigned to the resource domain, the search score being determined based on the number of times the users select the one or more resource locators corresponding to the selected search stock among the search result list.

6. The method of claim 4, wherein the operation of categorizing the resource domain includes categorizing the resource domain based on a current category of the resource domain and by comparing a magnitude of a current search score of the resource domain with a predetermined threshold.

7. The method of claim 6, wherein the operation of categorizing the resource domain includes categorizing the resource domain as the listed resource domain if the current category of the resource domain corresponds to the stopped resource domain and the magnitude of the current search score of the resource domain is not less than the predetermined threshold.

8. The method of claim 6, wherein the operation of categorizing the resource domain includes categorizing the resource domain as the stopped resource domain if the current category of the resource domain corresponds to the controlled resource domain and the magnitude of the current search score of the resource domain is less than the predetermined threshold.

9. The method of claim 6, wherein the operation of categorizing the resource domain includes categorizing the resource domain as the controlled resource domain if the current category of the resource domain corresponds to the listed resource domain but not the controlled resource domain and the magnitude of the current search score of the resource domain is less than the predetermined threshold.

10. The method of claim 6, wherein the operation of categorizing the resource domain includes categorizing the resource domain as the listed resource domain if the current category of the resource domain corresponds to the listing candidate resource domain and the magnitude of the current search score of the resource domain is not less than the predetermined threshold.

11. The method of claim 6, wherein the operation of categorizing the resource domain includes categorizing the resource domain as the not-listed resource domain if the current category of the resource domain corresponds to the listing candidate resource domain and the magnitude of the current search score of the resource domain is less than the predetermined threshold.

12. The method of claim 6, wherein the operation of categorizing the resource domain includes categorizing the resource domain as the listing candidate resource domain if the current category of the resource domain corresponds to the not-listed resource domain and the magnitude of the current search score of the resource domain is not less than the predetermined threshold.

13. The method of claim 8, further comprising requesting a stockholder of the search stocks, which is categorized as the stopped resource domain, to hold the search stocks or redeem the search stocks at a face-value.

14. The method of claim 1, wherein the search stocks are traded using virtual stock cyber money.

15. The method of claim 14, wherein the virtual stock cyber money is exchanged with a different kind of cyber money at a predetermined reference exchange rate.

16. The method of claim 13, wherein, if the stockholder redeems the search stocks, the search stocks are redeemed at an exchanging rate that is determined according to the search score assigned to the resource domain.

17. The method of claim 5, wherein the operation of categorizing the resource domain includes categorizing the resource domain based on a current category of the resource domain and by comparing a magnitude of a current search score of the resource domain with a predetermined threshold.

18. A system for providing a virtual stock exchange service allowing users to buy and sell issued search stocks, each search stock corresponding to one or more resource locators, comprising a server for conditionally listing and de-listing a selected search stock on the virtual stock exchange service based on a monitored search trend associated with the one or more resource locators corresponding to the selected search stock.

19. The system of claim 18, wherein the one or more resource locators corresponding to the selected search stock are associated with a resource domain included in a search pool and are listed in a search result list generated by a search engine.

20. The system of claim 19, wherein the server categorizes the resource domain as one of a not-listed resource domain, a listing candidate resource domain, a listed resource domain and a stopped resource domain based on the monitored search trend.

21. The system of claim 20, wherein the monitored search trend is indicated by a search score assigned to the resource domain, the search score being determined based on the number of times the one or more resource locators corresponding to the selected search stock are included in the search result list.

22. The system of claim 20, wherein the monitored search trend is indicated by a search score assigned to the resource domain, the search score being determined based on the number of times the users select the one or more resource locators corresponding to the selected search stock among the search result list.

23. The system of claim 21, wherein the server categorizes the resource domain based on a current category of the resource domain and by comparing a magnitude of a current search score of the resource domain with a predetermined threshold.

24-35. (canceled)

36. Logic encoded in one or more tangible media for execution and when executed operable to cause the one or more processors to:
provide a virtual stock exchange service allowing users to buy and sell issued search stocks, each search stock corresponding to one or more resource locators; and
conditionally list and de-listing a selected search stock on the virtual stock exchange service based on a monitored search trend associated with the one or more resource locators corresponding to the selected search stock.
